(19) United States
(12) Patent Application Publication
(10) Pub. No.: US 2010/0157725 A1
(43) Pub. Date: Jun. 24, 2010

(54) Roller Bearing for a Fluid-Agitating Element and Associated Vessel

(76) Inventors: Alexandre N. Terentiev, Lexington, KY (US); Albert Werth, Kewadin, MI (US); Philip M. Mantey, Bay Village, OH (US); Sergey Terentyev, Lexington, KY (US)

Correspondence Address: KING & SCHICKLI, PLLC, 247 NORTH BROADWAY, LEXINGTON, KY, 40507, US

(21) Appl. No.: 12/527,925

(22) PCT Filed: Feb. 21, 2008
(86) PCT No.: PCT/US08/54625

§ 371 Date: Mar. 10, 2010

Related U.S. Application Data
(60) Provisional application No. 60/890,955, filed on Feb. 21, 2007.

(51) Int. Cl. F16C 33/58; B01F 13/08; B01F 7/00

(52) U.S. Cl. 366/331; 384/622

(57) ABSTRACT

In a vessel, such as a flexible bag, a fluid is received and agitated using an internal fluid-agitating element driven by an external motive device and supported by a bearing, such as a roller bearing. The bearing may comprise a thrust bearing having at least one race fabricated of polyvinylidene fluoride and a plurality of associated rollers, preferably comprising a ceramic material, such as silicon nitride. Experiments show beneficial results in terms of particle generation when this particular combination of materials is used in the context of agitating fluids, and benefits as well when different materials are used to form the rollers.

This application claims the benefit of U.S. Provisional Patent Application Ser. No. 60/890,955, filed Feb. 21, 2007, the disclosure of which is incorporated herein by reference.

### TECHNICAL FIELD

The present invention relates generally to fluid agitation and, more particularly, to a roller bearing for a fluid-agitating element and associated vessel, and especially a collapsible mixing vessel, or bag.

### BACKGROUND OF THE INVENTION

Most pharmaceutical solutions and suspensions manufactured on an industrial scale require highly controlled, thorough mixing to achieve a satisfactory yield and ensure a uniform distribution of ingredients in the final product. Perhaps the most common proposal for stirring such a fluid is to use a rotating, permanent magnet bar covered by an inert layer of TEFLON, glass, or the like. The magnetic “stirrer” bar is placed on the bottom of the agitator vessel and rotated by a driving magnet positioned external to the vessel.

Of course, the use of such an externally driven magnetic bar avoids the need for a dynamic bearing, seal or other opening in the vessel to transfer the rotational force from the driving magnet to the stirring magnet. Therefore, a completely enclosed system is provided. This of course prevents leakage and the potential for contamination created by hazardous materials (e.g., cytotoxic agents, solvents with low flash points, blood products, etc.), eases clean up, and allows for the desirable sterile interior environment to be maintained, all of which are considered significant advantages.

Despite these advantages, a substantial problem is the creation of unwanted friction between the fluid-agitating element and the vessel. The use of a conventional roller bearing would help to provide the desired low friction support for the fluid-agitating element as it rotates. However, in many applications, sterility is of significant importance, and conventional roller bearings are typically not designed for use in such an environment. During the mixing of pharmaceuticals or like products for eventual introduction into living creatures, the presence of contaminants, and particularly shed particles, can require costly remediation steps, such as rigorous filtering, and can be deleterious if not kept in check or controlled. Conventional bearings are also costly to manufacture and expensive to purchase, and consequently are generally not considered disposable items.

Thus, a need is identified for an improved manner of ensuring that the desired low friction support is provided for a fluid-agitating element in a mixing vessel, such as a bag, actuated by an external motive device. The improvement provided by the invention would be easy to implement using existing manufacturing techniques and without significant additional expense. Overall, a substantial gain in efficiency and ease of use would be realized as a result of the improvement, and would greatly expand the potential applications for which advanced mixing systems may be used.

### SUMMARY OF THE INVENTION

In accordance with one aspect of the invention, an apparatus for use in agitating a fluid in a vessel is provided. The apparatus comprises a fluid-agitating element for positioning in the vessel and a bearing for rotatably supporting the fluid-agitating element. The bearing comprises first and second races, at least one of which comprises polyvinylidene fluoride, and a plurality of rollers.

Preferably, the rollers comprise a ceramic material and, most preferably, silicon nitride, but may also comprise metal, such as for example stainless steel. Even more preferably, both the first and second races comprise polyvinylidene fluoride (PVDF). The bearing may be a thrust bearing, with the rollers taking the form of balls. In one particular embodiment, the first race is unitary with the fluid-agitating element, which preferably is at least partially magnetic.

Another aspect of this disclosure is an apparatus for use in agitating a fluid in a vessel. The apparatus comprises a fluid-agitating element for positioning in the vessel and a thrust bearing for rotatably supporting the fluid-agitating element. The thrust bearing includes a first race integral with the fluid-agitating element and a second race spaced from and generally opposite the second race. The thrust bearing further includes a plurality of rollers for engaging at least one of the first and second races during rotation of the fluid-agitating element.

In one embodiment, a receiver (such as a post) supported by the vessel receives and holds the fluid-agitating element. The receiver may be generally concentric with the first race, and may further include a retainer for retaining the fluid-agitating element on the receiver. Most preferably, the retainer forms a portion of the receiver. The retainer may also be connected to the second race, so as to couple with the fluid-agitating element to retain the rollers within a space between the first and second races.

In another aspect of the disclosure, the apparatus further includes a vessel capable of receiving and holding the fluid and the fluid-agitating element. The vessel includes a flexible portion (such as in the case of a bag) and a rigid portion. A fluid-agitating element includes an upper race, and the rigid portion of the vessel includes a lower race in a position generally opposite the upper race. A plurality of rollers positioned between the upper and lower races provided the desirable low-friction rotation for the fluid-agitating element.

### BRIEF DESCRIPTION OF THE DRAWINGS

FIG. 1 is a partially schematic, partially cross-sectional side view of one embodiment of the present invention including a vessel in the form of a bag having a flexible portion and a rigid portion;

FIG. 1a is a partially schematic, partially cross-sectional, enlarged cutaway side view of the rigid portion of the vessel in the embodiment of FIG. 1;

FIG. 1b is a partially schematic, partially cross-sectional, enlarged cutaway side view of the fluid-agitating element in the embodiment of FIG. 1;

FIG. 1c is an enlarged partially cutaway side view showing one possible manner of attaching a first receiver in the form of a post to the rigid portion of the vessel;

FIG. 2 is a partially schematic, partially cross-sectional side view showing the vessel of FIG. 1 positioned in a rigid vessel, with the fluid-agitating element aligned with and levitated/rotated by an adjacent motive device;

FIGS. 3, 3a, and 3b illustrate various embodiments of support arrangements, each including a roller bearing for supporting the fluid-agitating element;

FIG. 4 is a partially cross-sectional, partially cutaway view of still a further embodiment of a support arrangement incorporating a roller bearing for supporting the fluid-agitating element;

FIG. 5 is an exploded view of the arrangement of FIG. 4;

FIG. 6 is a top plan view of a lower race forming part of the roller bearing of FIG. 4; and

FIG. 7 is an exploded view of a fluid-agitating element.

### DETAILED DESCRIPTION OF THE INVENTION

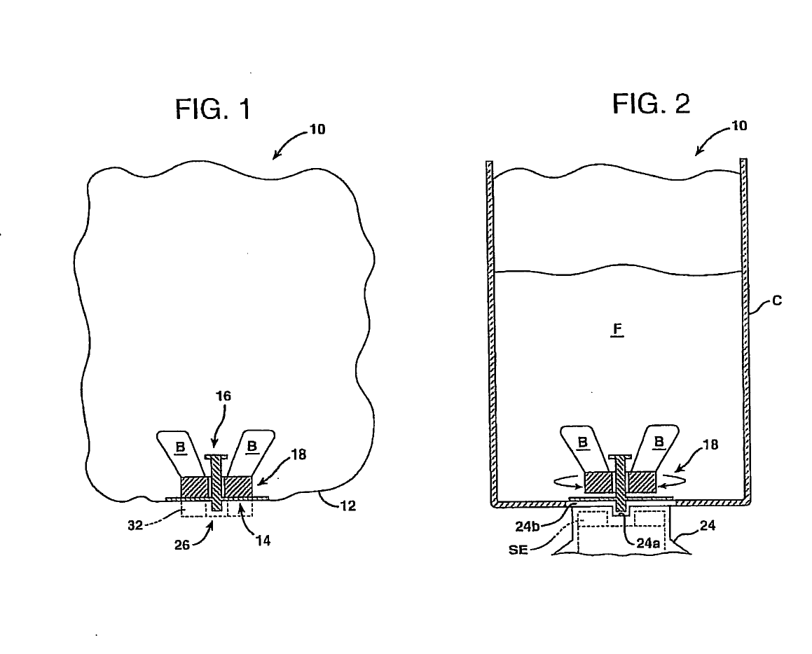

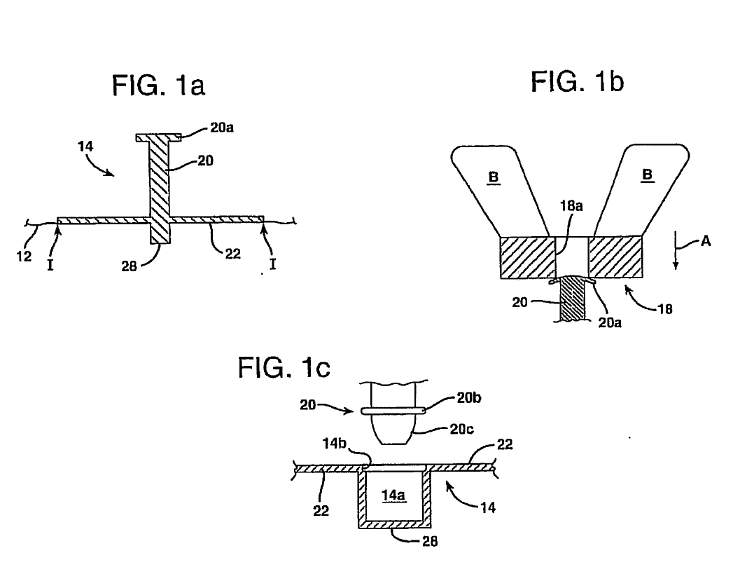

Reference is now made to FIG. 1, which discloses one embodiment of the vessel of the present invention in the form of a bag 10, which of course is collapsible when empty. In this embodiment, the bag 10 includes a body having a flexible or non-rigid portion 12, which is illustrated schematically, and a rigid or stiff portion 14, which is shown in cross-section. The bag 10 may be hermetically sealed and may have one or more openings or fittings (not shown) for introducing or recovering a fluid. Alternatively, the bag 10 may be unsealed or open-ended. The particular geometry of the bag 10 employed normally depends on the application and is not considered critical to the invention. For example, in the case of a sterile fluid, a hermetically sealed, pre-sterilized bag with an aseptic fitting might be desirable; whereas, in the case where sterility is not important, an open-ended or unsealed bag might be suitable. The main important point is that the bag 10 is capable of receiving and at least temporarily holding a fluid (which is used herein to denote any substance capable of flowing, as may include liquids, liquid suspensions, gases, gaseous suspensions, or the like, without limitation).

The rigid portion 14 includes a first receiver 16 for receiving and holding a fluid-agitating element 18 at a home location (or expected position), when positioned in the bag 10. It is noted that “holding” as used herein defines both the case where the fluid-agitating element 18 is directly held and supported by the first receiver 16 (see below) against any significant side-to-side movement (save tolerances), as well as where the first receiver 16 merely limits the fluid-agitating element to a certain degree of side-to-side movement within the bag 10. In this embodiment, an opening 18a is provided in the fluid-agitating element 18 and the first receiver 16 is a post 20 projecting toward the interior of the bag 10 (see FIGS. 1a and 1b). The post 20 is sized for receiving the fluid-agitating element 18 by extending through the opening 18a formed in the body 18b thereof (which is depicted as being annular, but not necessarily circular in cross-section). As illustrated in FIG. 1, it is preferable that the size of the opening 18a is such that the fluid-agitating element 18 may freely rotate and move in the axial direction along the post 20 without contacting the outer surface thereof. Despite this freedom of movement, the post 20 serving as the first receiver 16 is still considered to hold, confine, or keep the fluid-agitating element 18 at a home location or expected position within the vessel 20 by contacting the surface adjacent to the opening 18a as a result of any side-to-side movement (the boundaries of which are defined by the dimensions of the opening).

The flexible portion 12 of the bag 10 may be made of thin (e.g., having a thickness of between 0.1 and 0.2 millimeters) polyethylene film. The film is preferably clear or translucent, although the use of opaque or colored films is also possible. The rigid portion 14 including the post 20 may be formed of plastic materials, such as high density polyethylene (HDPE), ultrahigh molecular weight (UHMW) polyethylene, or like materials. Of course, these materials do have some inherent flexibility when used to form relatively thin components or when a moderate amount of bending force is applied thereto. Despite this flexibility, the rigid portion 14 is distinguished from the flexible portion 12, in that it generally maintains its shape under the weight of any fluid introduced in the bag 10.

Optionally, the post 20 may include a portion 20a for capturing the fluid-agitating element 18 and assisting in holding it thereon. The portion 20a is preferably oversized and forms the head or end of the post 20. By “oversized,” it is meant that at least one dimension (length, width, diameter) of this portion 20a of the post 20 is greater than the corresponding dimension of the opening 18a in the fluid-agitating element 18. For example, the portion 20a is shown in FIG. 1 as being disc-shaped, such that it provides the head end of the post 20 with a generally T-shaped cross section. To prevent interference with the levitation and rotation of the fluid-agitating element 18, the oversized portion 20a is strategically positioned at a certain distance along the post 20. In the case where it is oversized, the post 20 may be removably attached to the rigid portion 14 through the opening 18a in the fluid-agitating element 18 (such as by providing a threaded bore in the rigid portion for receiving a threaded end of the post, or as shown in FIG. 1c, a bore 14a having a groove 14b for establishing a snap-fit engagement with a corresponding projection 20b on a tapered end portion 20c of the post). In the case where the post 20 is unitarily formed with the rigid portion 14 and includes an oversized head portion 20a, this portion should be sufficiently thin such that it flexes or temporarily deforms to allow the fluid-agitating element 18 to pass initially (see FIG. 1b and note action arrow A, which demonstrates the direction of force for deforming the oversized head 20a such that it passes through the opening 18a).

Alternatively, this portion 20a of the post 20 need not be oversized, as defined above, but instead may simply be sufficiently close in size to that of the opening 18a such that the fluid-agitating element 18 must be precisely aligned and register with the post 20 in order to be received or removed. In any case, it is again important to note that the fluid-agitating element 18 is held in place in the vicinity of the post 20, but remains free of direct attachment. In other words, while the first receiver 16 (post 20) confines or holds the fluid-agitating element 18 at a home location or expected position within the bag 10, it is still free to move side-to-side to some degree (which in this case is defined by the size of the opening 18a), and to move along the first receiver 16 in the axial direction (vertical, in the embodiment shown in FIG. 1), as is necessary for levitation.

As perhaps best shown in FIG. 1a, the rigid portion 14 in this embodiment further includes a substantially planar peripheral flange 22. The flange 22 may be any shape or size, and is preferably attached or connected directly to the bag 10 at the interface I between the two structures (which may be created by overlapping the material forming the flexible portion 12 of the bag on an inside or outside surface of the flange 22 to form an overlapping joint, or possibly in some cases by forming a butt joint). In the case where the bag 10 and flange 22 are fabricated of compatible plastic materials, the connection may be made using well-known techniques, such as ultrasonic or thermal welding (heat or laser) at the interface to form a seal (which is at least liquid-impervious and preferably hermetic). Alternatively, other means of connection (e.g., adhesives), may be used at the interface I, although this is obviously less preferred in view of the desirability in most cases for the more reliable, leak-proof seal afforded using welding techniques. In either case, the judicious use of inert sealants may be made along the joint thus formed to ensure that a leak-proof, hermetic seal results. As discussed further below, the need for such an interface may be altogether eliminated by simply affixing the rigid portion 14 to an inside or outside surface of the bag 10.

As should be appreciated, the bag 10 shown in FIG. 1 may be manufactured as described above, with the fluid-agitating element 18 received on the post 20 (which may be accomplished using the techniques shown in FIGS. 1b and 1c). The empty bag 10 may then be sealed and folded for shipping, with the fluid-agitating element 18 held at the home location by the post 20. Holding in the axial direction (i.e., the vertical direction in FIG. 1) may be accomplished by folding the bag 10 over the post 20, or by providing the portion 20a that is oversized or very close in size to the opening 18a in the fluid-agitating element 18.

When ready for use, the bag 10 is then unfolded. It may then be placed in a rigid or semi-rigid support structure, such as a container C, partially open along at least one end such that at least the rigid portion 14 remains exposed (see FIG. 2). Fluid F may then be introduced into the bag 10, such as through an opening or fitting (which may be a sterile or aseptic fitting, in the case where the bag 10 is pre-sterilized or otherwise used in a sterile environment). As should be appreciated, in view of the flexible or non-rigid nature of the bag 10, it will generally occupy any adjacent space provided in an adjacent support structure or container C when a fluid F (liquid or gas under pressure) is introduced therein (see FIG. 2).

An external motive device 24 is then used to cause the fluid-agitating element 18 (which is at least partially magnetic or ferromagnetic) to at least rotate to agitate any fluid F in the bag 10. In the embodiment of FIG. 2, the fluid-agitating element 18 is at least partially magnetic and is shown as being levitated by the motive device 24, which is optional but desirable. As described in U.S. Pat. No. 6,416,215 (the disclosure of which is incorporated herein by reference), the levitation may be provided by a field-cooled, thermally isolated superconducting element SE (shown in phantom in FIG. 2) positioned within the motive device 24 and thermally linked to a cooling source (not shown). As also described therein, the fluid-agitating element 18 may then be rotated by rotating the superconducting element SE (in which case the fluid-agitating element 18 should produce an asymmetric magnetic field, such as by using at least two spaced magnets having alternating polarities). Another option is to use a separate drive structure (e.g., an electromagnetic coil) to form a coupling capable of transmitting torque to the particular fluid-agitating element (which may be “levitated” by a hydrodynamic bearing; see, e.g., U.S. Pat. No. 5,141,327 to Shiobara). While it is of course desirable to eliminate the need for a dynamic seal or opening in the bag through which a drive structure (such as a shaft) extends, the particular means used to levitate and/or rotate the fluid-agitating element 18 (which is preferably magnetic) is not considered critical to practicing the inventions disclosed herein.

The fluid-agitating element 18 is also depicted as including a plurality of vanes or blades B to improve the degree of fluid agitation. If present, the vanes or blades B preferably project in a direction opposite the corresponding surface of the rigid portion 14. The particular number, type, and form of the vanes or blades B is not considered important, as long as the desired degree of fluid agitation for the particular application is provided. Indeed, in applications where only gentle agitation is required, such as to prevent damage to delicate suspensions or to merely prevent stagnation of the fluid F in the bag 10, the vanes or blades B need not be provided, as a rotating smooth-walled annular element 18 still provides some degree of fluid agitation.

As explained above, it is important to not only know the general location or position of the fluid-agitating element 18 within the bag 10, but also to assure its position relative to the motive device 24. To do so, the rigid portion 14 may be provided with a second receiver 26 to facilitate the correct positioning of the motive device 24 relative to the fluid-agitating element 18 when held at the home location. In the embodiment shown in FIGS. 1a and 1b, the second receiver 26 takes the form of a second' post 28 projecting in a direction opposite the first post 20. Preferably, the second post 28 is essentially coaxial with the first post 20 (although the post 20 may be a separate component that fits into a receiver 14a defined by the second post 28; see FIG. 1c) and is adapted to receive an opening 24a, such as a bore, in the adjacent end face 24b forming a part of the housing for the motive device 24. Consequently, the second post 28 helps to assure that the alignment between the fluid-agitating element 18 (which is generally held in the vicinity of the first receiver 16/post 20, which is the home location) and the motive device 14 forms the desired coupling, for transmitting the levitation or rotational force.

Preferably, the second receiver 26, such as second post 28, has a cross-sectional shape corresponding to the shape of the opening 24a. For example, the second post 28 may be square in cross-section for fitting in a correspondingly-shaped opening 24a or locator bore. Likewise, the second post 28 could have a triangular cross-sectional shape, in which case the opening 28 would be triangular. Myriad other shapes could also be used, as long as the shape of the second receiver 26 compliments that of the opening 24a such that it may be freely received therein. In this regard, a system of matching receivers and openings may be used to ensure that the fluid-agitating element 18 in the bag 10 corresponds to a particular motive device 24. For example, in the case where the fluid-agitating element 18 includes a particular arrangement of magnets producing a magnetic field that corresponds to a particular superconducting element or drive structure, the second receiver 26 may be provided with a certain shape that corresponds only to the opening 24 in the motive device 24 having that type of superconducting element or drive structure. A similar result could also be achieved using the relative sizes of the second receiver 26 and the opening 24a, as well as by making the size of the opening 18a in the fluid-agitating element 18 such that it only fits on a first receiver 16 having a smaller width or diameter, and then making the second receiver 26 correspond only to a motive device opening 24a corresponding to that fluid-agitating element 18.

In many past arrangements where a rigid vessel is used with a fluid-agitating element directly supported by a bearing, an external structure is provided to which a motive device could be directly or indirectly attached and held in a suspended fashion. This structure serves to automatically align the motive device with the fluid-agitating element supported therein. However, a bag 10 per se is generally incapable of providing reliable support for the motive device 24, which can weigh as much as twenty kilograms. Thus, the motive device 24 in the embodiments disclosed herein for use with a vessel in the form of a bag 10 is generally supported from a stable support structure (not shown), such as the floor, a wheeled, height adjustable platform, or the like. Since there is thus no direct attachment with the bag 10, the function performed by the second receiver 26 in aligning this device with the fluid-agitating element 18 is an important one.

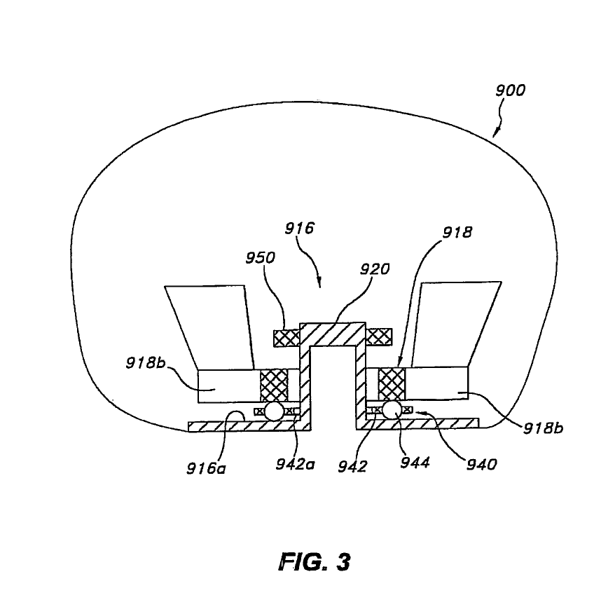

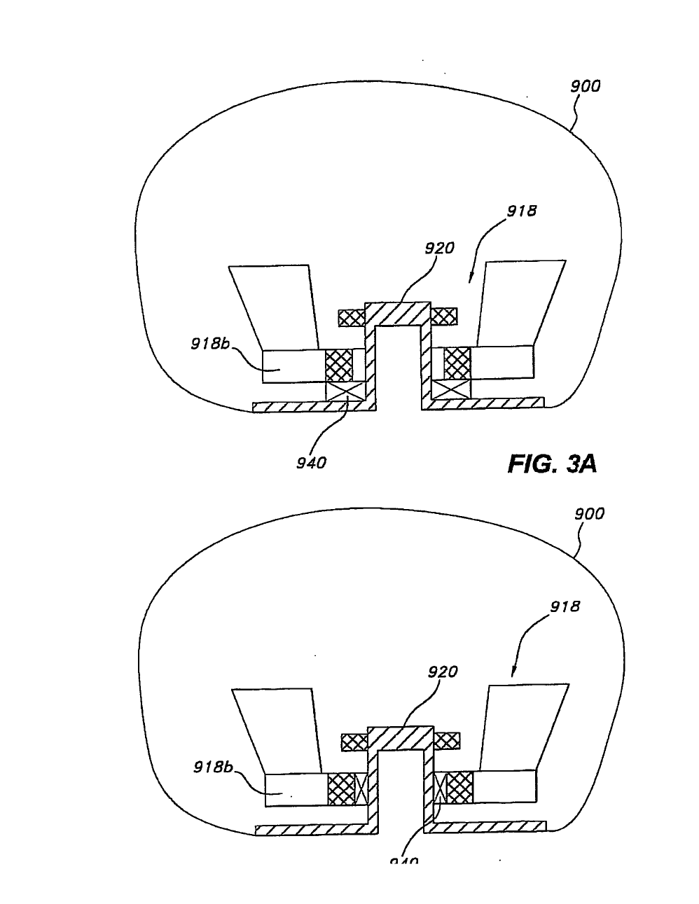

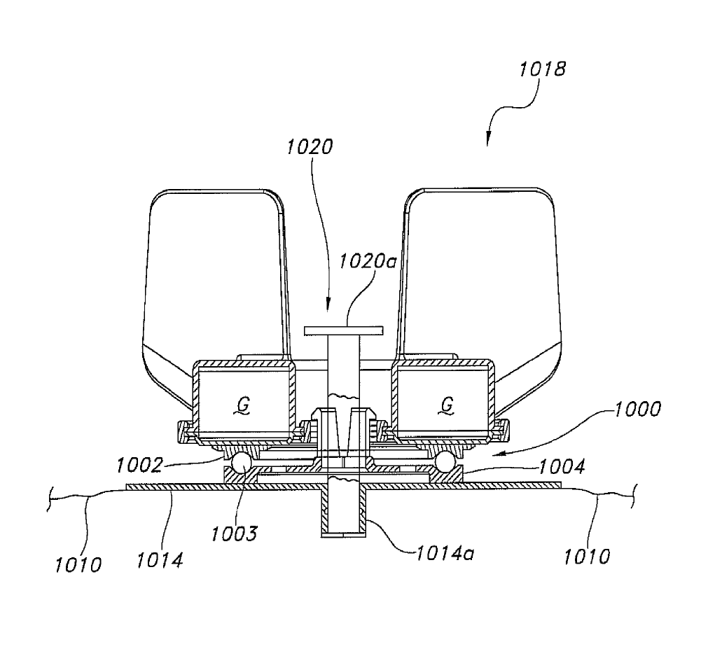

FIG. 3 illustrates an embodiment in which the vessel is in the form of a collapsible bag 900 including a rigid portion defining a first rigid receiver 916 with a post 920 projecting toward an interior compartment of the bag. Adjacent the post 920, and thus associated with the receiver 916 forming a portion of the bag (a collapsible vessel), is a low-friction bearing 940 for supporting the fluid-agitating element 918. Preferably, this bearing 940 is a separate structure from the post 920 (and thus may bodily rotate relative to it or, in other words, rotate as a whole), and includes a retainer (such as a ring 942) and a plurality of discrete roller elements. The fluid-agitating element 918 may be of the type described above and shown in FIG. 1, and thus includes a magnet 918b for connecting with an external drive structure (not shown) via magnetic coupling in order to induce rotation at the desired speed.

The post 920 in the illustrated embodiment projects through an opening 942a in the ring 942 forming part of the bearing 940. This ring 942, in turn, supports the plurality of roller elements, such as spherical roller balls 944 (and thus forms a ball thrust bearing, although a roller thrust bearing could also be used in this embodiment). These balls 944 at least engage a corresponding rigid seating surface 916a associated with the receiver 916, and preferably project from both sides of the ring 942 in an opposed fashion so as to also engage a corresponding surface of the fluid-agitating element 918 and provide the desired low-friction support therefor. A separate locking element 950 associated with the post 920 (including possibly by way of friction fit, snap fit, or threaded engagement) may retain or capture the fluid-agitating element 918 and bearing 940 in place.

In use, a magnetic coupling may be formed between a selected external motive device (such as a “mag” drive or otherwise) to rotate the fluid agitating element 918. As the rotation is effected, the fluid agitating element 918 thus engages the bearing 940, which provides desirable low-friction support. This is the case even if the balls 944 only project toward and engage the rigid seating surface 916a of the receiver 916.

The engagement surfaces of the receiver 916 and fluid-agitating element 918 may be made of plastic, which depending on the conditions may be subject to wear and the creation of deleterious wear particles. To avoid this, it is possible to interject a wear-resistant (e.g., metal or stainless steel) surface or plate (not shown) between either of the adjacent surface of the fluid-agitating element 918, the seating surface 916a, or both. This arrangement provides suitable contact surface(s) for the rolling elements of the bearing 940.

FIGS. 3a and 3b show alternate embodiments. In FIG. 3A, a roller bearing 940 is, for example, a ball bearing, attached or mounted to the seating surface adjacent the receiver (post 920) and the other race (such as the outer race, not shown) attached or mounted to the fluid-agitating element 918. FIG. 3b illustrates an alternative embodiment in which a roller bearing 940, again preferably in the form of a ball bearing, is attached directly to the post 920, respectively.

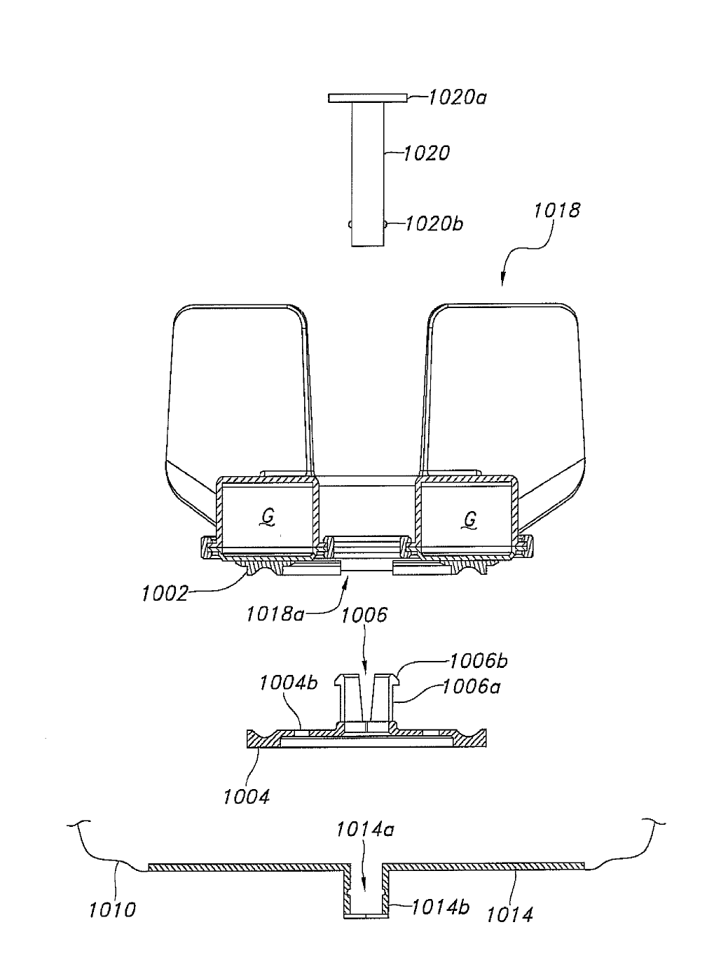

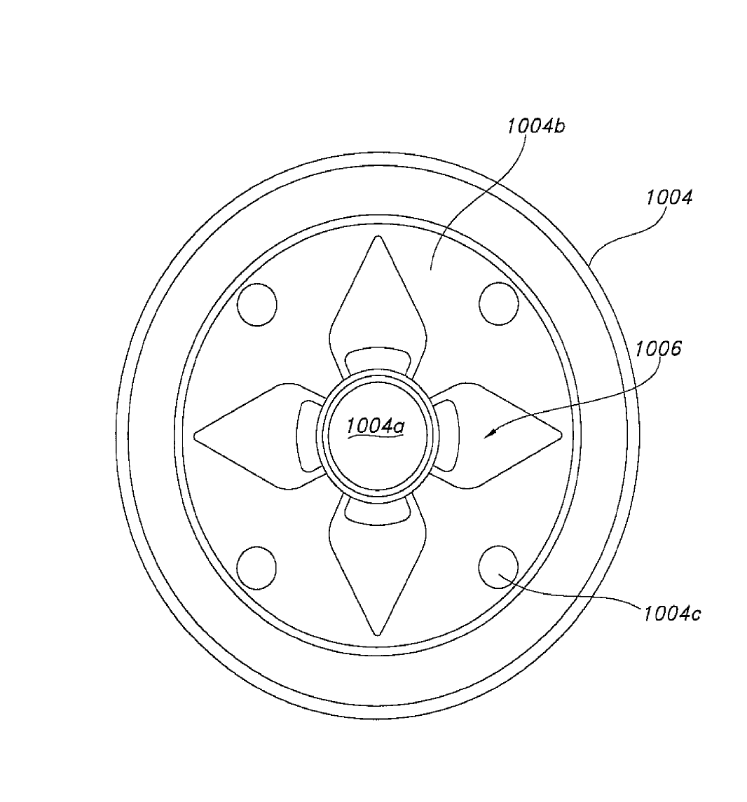

Turning now to FIG. 4, still a further embodiment of a support arrangement for a fluid-agitating element 1018 is shown. In this embodiment, a roller bearing in the form of a thrust bearing 1000 supports the fluid-agitating element 1018, which preferably is at least partially magnetic or ferromagnetic (note magnets G of the preferred embodiment). Preferably, the bearing 1000 comprises a first or upper race 1002 that is integral with the fluid-agitating element 1018, and a second or lower race 1004 that is supported by the vessel, such as by rigid portion 1014. As with the other embodiments, the vessel may further comprise a flexible portion, such as a bag 1010 (partially cutaway in FIGS. 4 and 5, but see FIG. 1 for the full depiction) connected or secured to the rigid portion 1014, preferably such that a hermetic seal is formed to foreclose any fluid leakage or contamination.

A plurality of rollers, such as balls 1003, are positioned for engaging the races 1002, 1004 to provide the desirable low friction for the fluid-agitating element 1018 during rotation. The number of rollers provided may vary depending on their size or the particular application, but should be sufficient to ensure that even, reliable support is provided for the fluid-agitating element. To retain the balls 1003 of the illustrated embodiment, while permitting the desired rolling movement, the channels or tracks of the races 1002, 1004 for engaging the rollers are preferably U-shaped or V-shaped, but could take other forms (possibly depending on the shape of the rollers) as long as the retention function is provided.

The lower race 1004 includes a structure for retaining it with respect to the upper race 1002 so as to contain and capture the rollers in the desired position, as well as for receiving the fluid-agitating element 1018, to thus form a self-contained assembly. As perhaps best understood with reference to FIG. 5, this retaining structure may take the form of a catch 1006 adapted to flex so as to pass through an opening 1018a in the fluid-agitating element 1018 in one direction, and then return to its original position. Preferably, this is achieved by providing the catch 1006 with a plurality of spaced apart, elongated legs 1006a, each including a peripheral lip or ledge 1006b. The spacing preferably is such that the legs 1006a may flex inwardly to pass through the opening 1018a in the fluid-agitating element 1018, but then snap back to assume their original condition.

In the assembled condition, as shown in FIG. 4, the catch 1006 thus interconnects the fluid-agitating element 1018 to the lower race 1004, such that the rollers are securely retained. However, the coupling is such that a limited degree of relative movement in the vertical direction results so as to not interfere with the formation and maintenance of any magnetic coupling used to drive or levitate the fluid-agitating element. As should be appreciated, this coupling arrangement in no way impedes the ability of the fluid-agitating element 1018 to rotate freely as a result of the interaction with a motive device external to the vessel, and also securely captures the rollers between the races 1002, 1004 during use.

As in several of the other embodiments, a receiver may also be provided for receiving and holding the fluid-agitating element 1018 within the vessel. In the illustrated embodiment, this receiver comprises a post 1020 having a retainer, such as an oversized head portion 1020a. This ensures that the assembled fluid-agitating element 1018 and lower race 1004 remain held in place during use. As discussed above, the post 1020 may be removable, such as by way of a snap-fit or friction fit formed in a bore 1014a in the rigid portion 1014 (such as between groove 1014b and protection 1020b). The lower race 1004 may also have an opening 1004a for receiving the post 1020 in a concentric fashion.

In accordance with one particularly preferred embodiment of the invention, special materials are used to form the races 1002, 1004 and the rollers, such as balls 1003. Specifically, at least one and preferably both of the races 1002, 2004 comprise a plastic material that is resistant to particle shedding as the result of the engagement with rollers. Most preferably, this material comprises polyvinylidene fluoride (PVDF). A specific example of this type of material is that identified by the KYNAR trademark. The rollers may be fabricated of durable, wear resistant materials, such as metal (and, preferably, a type that is non-corrosive, such as stainless steel). Preferably, the rollers comprise a ceramic material and, most preferably, silicon nitride. As should be appreciated, bearing 940 can also be fabricated of such materials.

During experiments, rollers comprising silicon nitride when used in connection with races 1002, 1004 comprising PVDF had surprisingly little to no particle shedding after substantial use. The resulting assembly also has a minimal cost in terms of materials, and thus can simply be disposed of or discarded when the fluid processing is complete, preferably along with the vessel. The following example of experiments conducted is illustrative of the benefits and advantages achieved:

### EXAMPLE

An experiment was conducted using rollers in the form of 7/32″ 316 stainless steel balls from McMaster and 7/32″ balls from the Barden Corp. The races 1002, 1004 used were formed of KYNAR. The vessel comprised a rigid plastic water tank, and rotation of the magnetic impeller serving as the fluid-agitating element 1018 was provided by an external magnetic drive system. Three different volumes of water (100 ml, 300 ml, and 1L) were used.

Clean water was obtained using a four step Barnsted purification system (Model D4541 Epure, 8.3 MegaOhm cm). For post mixing determination of particle generation, an optical microscope (OLYMPUS BX-60, MPlan OLYMPUS 10x/0.25×2 BD) was used, along with a bright line counting chamber (Hausser Scientific).

Initially, the balls, the lower race, the plastic tank for the water, and the impeller were cleaned: first in acetone, then in pure water. The balls were further cleaned ultrasonically.

The first experiment was performed using one liter (1L) of clean water. Then the volume of water was reduced to 300 ml and to 100 ml. The system was rotated during 6.5-8 hours. After the rotation was stopped, the water probe was taken by the pipette from the plastic tank and checked under microscope for the presence of the particles using the bright line counting chamber. Furthermore, the surface of the balls before and after experiments was investigated under optical microscope for comparison. The surface of the races 1002, 1004 in contact with the balls were also studied using the optical microscope in an effort to detect any damage.

For the metallic balls, no particles were observed in the water after rotation during 8 h in 1 l water. No damage of the balls surface was observed after the experiment. However, a reduction in the volume of water (8 h in 100 ml) generated a large amount of metallic particles. The surface of the ball also lost its shiny luster. Further investigations under optical microscope revealed that the surface of the balls included traces resulting from ball collisions. On the other hand, no damage to the races 1002, 1004 was observed, and no KYNAR particles were found in the water.

Using metallic balls, rotation of the impeller during 7.5 h in 300 ml water generated approximately 5 particles per 0.1 mm³ water. The surface of the metallic balls after the experiment has been studied under optical microscope, and no damage was observed. The ceramic balls looked identical before and after the experiment. No damage to the races 1002, 1004 was observed, either.

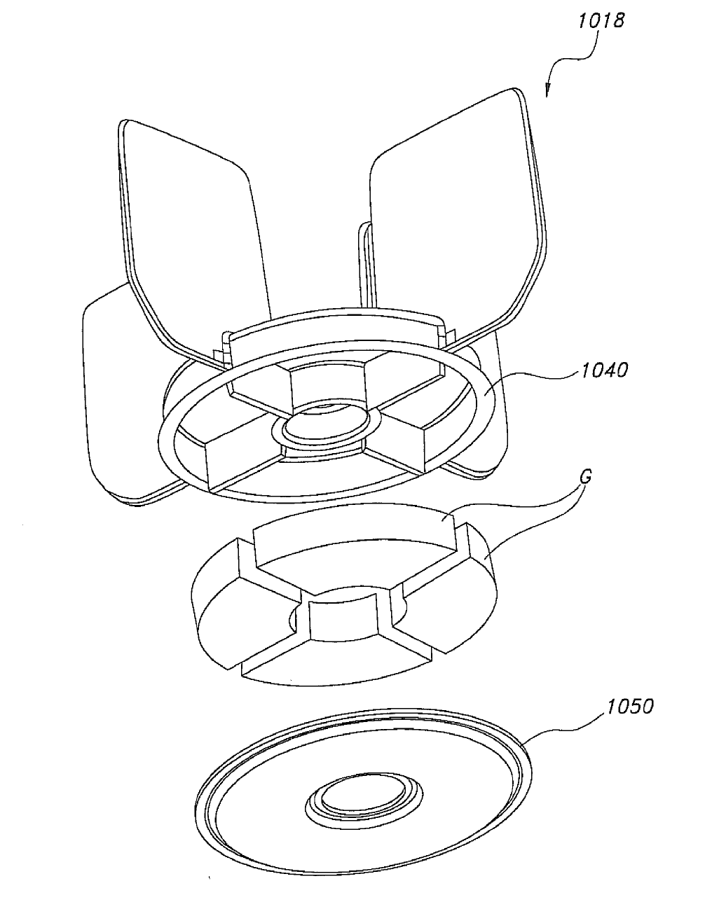

Referring now to FIG. 6 for an illustration of a further aspect of the disclosure, the lower race 1004 may further comprise a plate 1004b. This plate 1004b may include one or more peripheral openings 1004c in addition to any opening 1004a for receiving the post 1020, if used. Fluid may of course pass through these openings 1004c to stimulate circulation and eliminate stagnation zones.

FIG. 7 illustrates one possible construction of the fluid-agitating element 1018 shown in FIGS. 4-6. An upper portion 1040 is connected to a lower portion 1050 to capture a plurality of magnets G, preferably in the form of arcuate segments. The lower portion 1050 may connect directly to and/or form a unitary structure with the lower race 1004 of the thrust bearing 1000, such as by using adhesives, welding, or co-molding.

The foregoing descriptions of various embodiments of the present inventions have been presented for purposes of illustration and description. These descriptions are not intended to be exhaustive or to limit the invention to the precise forms disclosed. Obvious modifications are possible. For example, the lower race 1004 can be built directly into the rigid portion 1014, or may have a catch for connecting it thereto. The embodiments described provide the best illustration of the principles of the invention and its practical applications to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. An apparatus for use in agitating a fluid in a vessel, comprising:
a fluid-agitating element for positioning in the vessel; and
a bearing for rotatably supporting the fluid-agitating element;
said bearing comprising first and second races, at least one of said races comprising polyvinylidene fluoride, and a plurality of rollers.

2. The apparatus of claim 1, wherein the rollers comprise a ceramic material.

3. The apparatus of claim 2, wherein the rollers comprise silicon nitride.

4. The apparatus of claim 1, wherein the rollers comprise metal.

5. The apparatus of claim 1, wherein the first and second races comprise polyvinylidene fluoride.

6. The apparatus of claim 1, wherein the bearing comprises a thrust bearing.

7. The apparatus of claim 1, wherein the rollers comprise balls.

8. The apparatus of claim 1, wherein the first race is unitary with the fluid-agitating element.

9. The apparatus of claim 1, wherein the fluid-agitating element is at least partially magnetic.

10. An apparatus for use in agitating a fluid in a vessel, comprising:
a fluid-agitating element for positioning in the vessel; and
a thrust bearing for rotatably supporting the fluid-agitating element, said thrust bearing including a first race integral with the fluid-agitating element, a second race spaced from and generally opposite the second race, and a plurality of rollers for engaging at least one of said first and second races during rotation of the fluid-agitating element.

11. The apparatus of claim 10, further including a receiver supported by the vessel for receiving and holding the fluid-agitating element.

12. The apparatus of claim 11, wherein the receiver is generally concentric with the first race.

13. The apparatus of claim 11, further including a retainer for retaining the fluid-agitating element on the receiver.

14. The apparatus of claim 13, wherein the retainer forms a portion of the receiver.

15. The apparatus of claim 13, wherein the retainer is connected to the second race.

16. The apparatus of claim 15, wherein the retainer of the second race couples with the fluid-agitating element to retain the rollers within a space between the first and second races.

17. The apparatus of claim 11, wherein the receiver comprises a post projecting inwardly into an interior compartment of the vessel.

18. The apparatus of claim 10, wherein the second race comprises a plate including at least one opening for receiving the fluid.

19. The apparatus of claim 10, wherein the fluid-agitating element is at least partially magnetic.

20. The apparatus of claim 10, wherein the rollers comprise a ceramic material.

21. The apparatus of claim 10, wherein the rollers comprise silicon nitride.

22. The apparatus of claim 10, wherein the rollers comprise metal.

23. The apparatus of claim 10, wherein at least one of the first and second races comprises polyvinylidene fluoride.

24. The apparatus of claim 10, wherein the rollers comprise balls.

25. An apparatus for use in agitating a fluid, comprising:
a vessel capable of receiving and holding the fluid and the fluid-agitating element, said vessel including a flexible portion and a rigid portion;
a fluid-agitating element including an upper race;
said rigid portion of the vessel including a lower race in a position generally opposite the upper race; and
a plurality of rollers positioned between the upper and lower races.

26. The apparatus of claim 25, wherein the rigid portion of the vessel further includes a receiver for receiving and holding the fluid-agitating element.

27. The apparatus of claim 26, further including a retainer for retaining the fluid-agitating element on the receiver.

28. The apparatus of claim 27, wherein the retainer forms a portion of the receiver.

29. The apparatus of claim 27, wherein the retainer forms a portion of the lower race.

30. The apparatus of claim 27, wherein the retainer of the lower race couples with the fluid-agitating element to retain the rollers within a space between the upper and lower races.

31. The apparatus of claim 26, wherein the receiver comprises a post projecting inwardly into an interior compartment of the vessel.

32. The apparatus of claim 25, wherein the lower race comprises a plate including at least one opening for receiving the fluid.

33. The apparatus of claim 25, wherein the fluid-agitating element is at least partially magnetic.

34. The apparatus of claim 25, wherein the rollers comprise a ceramic material.

35. The apparatus of claim 25, wherein the rollers comprise silicon nitride.

36. The apparatus of claim 25, wherein the rollers comprise metal.

37. The apparatus of claim 25, wherein at least one of the first and second races comprises polyvinylidene fluoride.

38. The apparatus of claim 25, wherein the rollers comprise balls.

39. The apparatus of claim 25, wherein the vessel comprises a flexible bag.
